(19) United States
(12) Patent Application Publication
(10) Pub. No.: US 2025/0062342 A1
(43) Pub. Date: Feb. 20, 2025

(54) METHOD FOR DELITHIATING AT LEAST ONE LITHIUM AND TRANSITION-METAL NITRIDE

(71) Applicants: AMPERE S.A.S., Boulogne Billancourt (FR); CENTRE NATIONAL DE LA RECHERCHE SCIENTIFIQUE (CNRS), Paris (FR); UNIVERSITE PARIS EST CRETEIL VAL DE MARNE, Creteil (FR)

(72) Inventors: Nicolas EMERY, Montigny Le Bretonneux (FR); Olivier NGUYEN, Guyancourt Cedex (FR); Jean-Pierre PEREIRA-RAMOS, Marolles en Brie (FR); Yanlong ZHOU, Guyancourt Cedex (FR)

(73) Assignees: AMPERE S.A.S., Boulogne Billancourt (FR); CENTRE NATIONAL DE LA RECHERCHE SCIENTIFIQUE (CNRS), Paris (FR); UNIVERSITE PARIS EST CRETEIL VAL DE MARNE, Creteil (FR)

(21) Appl. No.: 18/721,890

(22) PCT Filed: Dec. 23, 2022
(86) PCT No.: PCT/FR2022/052499

§ 371 Date: Jun. 20, 2024

(30) Foreign Application Priority Data
Dec. 23, 2021 (FR) 2114373

(51) Int. Cl. H01M 4/58; C01G 45/00; C01G 49/00; H01M 4/04

(52) U.S. Cl. CPC H01M 4/58; C01G 45/006; C01G 49/009; H01M 4/04

(57) ABSTRACT

A method for delithiating a lithium and transition metal nitride. The method involves mixing an oxidising agent with the lithium and transition metal nitride and recovering the material obtained. The transition metal may be Mn, Fe, Co, Ni, Cu, or a mixture thereof. The material obtained by the method may be used as a negative electrode material for a lithium-ion battery.

The present invention relates to a method for delithiating a particular material, lithium and transition metal nitride. The present invention also relates to the use of the material obtained by the said method as a negative electrode material for a lithium-ion battery.

### TECHNICAL FIELD

Conventionally, Li-ion batteries comprise one or more positive electrodes, one or more negative electrodes, an electrolyte and a separator.

Li-ion batteries are being used increasingly as an autonomous energy source, particularly in applications related to electric mobility. This trend is explained in particular by densities of mass and volume energy which are significantly higher than those of conventional nickel cadmium (Ni-Cd) and nickel-metal hydride (Ni-MH) batteries, no memory effect, low self-discharge compared with other batteries, and the lower cost per kilowatt hour associated with this technology.

Li-ion batteries comprise active electrode materials that allow lithium ions to be inserted and deinserted during charging and discharging processes. These insertions and deinsertions need to be reversible so that the battery can store energy over several cycles.

Good mobility of the lithium ion in the structure and good electrical conductivity of the electrode material are essential properties that enable these batteries to be used at high charge and discharge speeds allowing high electrical power. The specific power of a battery is an important issue for automotive applications, as it means that lighter batteries can be used for the same amount of effort, and it also means that batteries can be used in safer conditions.

The fast charging of the Li-ion battery is also a key factor in the development of hybrid and other electric vehicles.

Currently, the positive electrode materials used in the Li-ion batteries are lithiated transition metal oxides, such as LiCoO₂, LiNi_{0.6}Mn_{0.2}Co_{0.2}O₂, LiFePO₄, or LiMn₂O₄. The negative electrode materials are insertion materials, such as graphite or lithium titanate (Li₄Ti₅O₁₂).

During the charging process, Li⁺ lithium ions are deintercalated from the positive electrode material and intercalated into the layers (in the case of graphite) or crystallographic sites (in the case of lithium titanate) of the negative electrode material.

If the charging current is high and the potential of the negative electrode material is too low, it is quite possible for the lithium to be deposited on the negative electrode, resulting in a reduction of the capacity of the battery cell and potentially leading to separator penetration and serious safety problems.

Lithium titanate is an interesting material for high-power batteries due to its high working potential (1.5 V vs Li+/Li) to avoid lithium plating. However, its capacity is still limited in relation to that of graphite. The capacity of graphite is more than twice that of lithium titanate.

Nitride-based electrode materials have also been developed, in particular lithium transition metal nitrides such as Li₇MnN₄ and Li₃FeN₂. These materials have almost twice the capacity of lithium titanate, while having a working potential of 1.18V vs. Li+/Li for Li₇MnN₄ and 1.25V vs. Li+/Li for Li₃FeN₂, respectively, and a good high-current performance.

These materials, Li₇MnN₄ and Li₃FeN₂, are described in U.S. Pat. No. 5,702,843 as electrode materials for secondary batteries. An advantage of using these materials as electrode materials is that the materials available for the electrodes can be applied directly. However, the working potential of these materials for use in cells is limited, as shown in U.S. Pat. No. 5,702,843. The in-cell performance is therefore unsatisfactory.

There is therefore still a need to develop electrode materials which overcome the disadvantages mentioned above.

Thus, the aim of the present invention is to develop a method for delithiating a lithium and transition metal nitride to obtain a material that can be used as a negative electrode active material for a lithium-ion battery.

### DISCLOSURE OF THE INVENTION

The subject-matter of the present invention is therefore a method for delithiating at least one lithium and transition metal nitride comprising the following steps:
a) mixing at least one oxidising agent with said lithium and transition metal nitride;
b) recovering the material obtained at the end of step a).

The method according to the invention makes it possible to obtain a delithiated material. Such a material makes it possible to avoid the initial discharge step which is conventionally carried out in a cell with the materials generally used in the prior art, such as for example the materials of formula Li₇MnN₄ or Li₃FeN₂. These materials are not delithiated materials. Thus, when these materials are used in a cell, an initial discharge step of the battery cell is required.

The subject-matter of the invention is also the use of the material obtained by the method according to the invention, as a negative electrode active material for lithium-ion batteries.

Other advantages and features of the invention will become clearer on examination of the detailed description and the accompanying drawings in which:

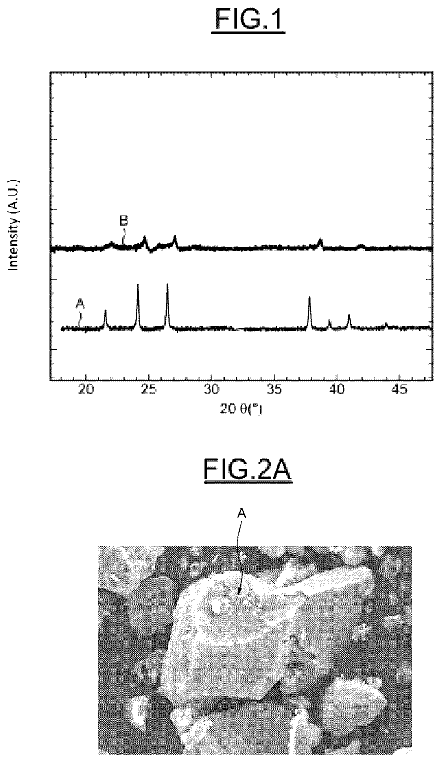

FIG. 1 shows diffractogram of the Li₇MnN₄ material and the material obtained at the end of the method according to the invention;

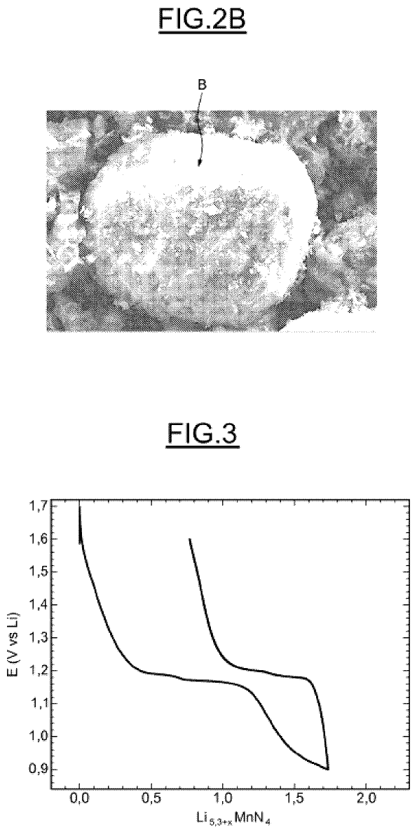

FIG. 2A is a scanning electron microscope image of the Li₇MnN₄ material;

FIG. 2B is a scanning electron microscope image of a material obtained by the method according to the invention;

FIG. 3 is a graph representing the galvanostatic curve of a material obtained by the method according to the invention against Li metal.

It should be noted that the expression “from . . . to . . . ” used in this description of the invention should be understood to include each of the limits mentioned.

The expression “at least one” means one or more.

As indicated above, according to step a) of the method according to the invention, at least one oxidising agent is mixed with the lithium and transition metal nitride.

Advantageously, the transition metal or metals are selected from Mn, Fe, Co, Ni, Cu and mixtures thereof.

Preferably, said lithium and transition metal nitride is selected from materials of formula Li₇MnN₄, Li₃FeN₂, Li_{2.6}Co_{0.4}N, Li_{2.0}Ni_{0.67}N and Li_{2.57}Cu_{0.43}N.

More preferably, said lithium and transition metal nitride is of formula Li₇MnN₄ or of formula Li₃FeN₂.

Preferably, said oxidising agent is selected from those belonging to the family of metallocenes in oxidised form.

Advantageously, said oxidising agent is selected from cobaltocenium salts, preferably from cobaltocenium hexafluorophosphate, cobaltocenium tetrafluoroborate, bis(pentamethylcyclopentadienyl)cobalt hexafluorophosphate, bis(pentamethylcyclopentadienyl)cobalt tetrafluoroborate hexafluorophosphate and mixtures thereof.

More preferably, said oxidising agent is selected from cobaltocenium hexafluorophosphate.

According to a preferred embodiment, the molar ratio between said oxidising agent and said lithium and transition metal nitride ranges from 0.5 to 3, preferably from 1 to 2.

In a preferred manner, step a) is performed in the presence of at least one solvent.

Advantageously, the solvent is selected from aprotic organic solvents, preferably from acetonitrile, tetrahydrofuran, dimethylformamide, dichloromethane, ethyl acetate and mixtures thereof, preferably from acetonitrile.

According to another embodiment, any solvent that can be used in a Li-ion battery electrolyte can also be used, preferably the solvent is selected from ethylene carbonate (denoted “EC”), propylene carbonate (denoted “PC”), dimethyl carbonate (denoted “DMC”), diethyl carbonate (denoted “DEC”) and ethyl and methyl carbonate (denoted “EMC”) and mixtures thereof.

According to another embodiment, the solvent selected from aprotic organic solvents, such as those mentioned above, may be in a mixture with the solvent that may be used in an Li-ion battery electrolyte, such as those mentioned above.

In a preferred manner, the solvent is acetonitrile.

As indicated above, according to step b) of the method according to the invention, the material obtained at the end of step a) is recovered.

Advantageously, the material can be recovered by centrifugation or by filtration.

The material can then be rinsed with solvent, preferably selected from the solvents mentioned above, possibly several times.

Then, the material can be dried in a vacuum.

The materials Li₇₋ₓMnN₄ (0<x≤2) and Li_{3-y}FeN₂ (0<y≤1.2) can be obtained in this way.

The subject-matter of the invention is also the use of the material obtained by the method according to the invention, as a negative electrode active material for lithium-ion batteries.

As indicated above, the method according to the invention is a method for delithiating at least one lithium and transition metal nitride.

A protocol for delithiating at least one lithium and transition metal nitride can be described according to an embodiment below.

Advantageously, an oxidising agent, such as those mentioned above, can first be added to a solvent, such as those mentioned above, to obtain a solution comprising said oxidising agent.

Then, lithium and transition metal nitride, such as for example Li₇MnN₄ or Li₃FeN₂, can be added to said solution. Said lithium and transition metal nitride can be in the form of powder.

The amount of lithium and transition metal nitride can be adjusted such that the molar ratio between said oxidising agent and said lithium and transition metal nitride can range from 0.5 to 3, preferably from 1 to 2.

The lithium and transition metal nitride can then be mixed in the said solution comprising said oxidising agent.

The temperature can then be adjusted to a temperature ranging from −5° C. to 50° C.

All of these steps can be carried out in a controlled environment, such as in a glove box.

Advantageously, the oxidising agent used can be a cobaltocenium salt. The colour of the solvent may change during the reaction. This is a signal that the reaction is in progress.

At the end of the reaction, the material obtained can be recovered.

Advantageously, the material can be separated from the solution by centrifugation or filtration.

The material can then be rinsed with solvent several times to remove any undesirable products. Then, the material can be dried in a vacuum.

The present invention will now be described more specifically with reference to examples, which are by no means limiting to the scope of the invention. However, the examples provide support for specific features, variants, and preferred embodiments of the invention.

### EXAMPLES

### Example 1: Method According to the Invention

The lithium and transition metal nitride of formula Li₇MnN₄ is used.

A diffractogram is made of the material in its initial state, as shown in FIG. 1 (curve A, material A). The characteristic peaks of Li₇MnN₄ can be identified on this diffractogram.

A scanning electron microscope image of the material in its initial state is taken, as shown in FIG. 2A (material A).

The delithiation takes place in a glove box at a temperature of 20° C. The molar ratio between said oxidising agent and said lithium and transition metal nitride is 1.5.

Approximately 320 mg (0.002 mol) Li₇MnN₄ is placed in an Erlenmeyer flask, then approximately 7.5 mL acetonitrile and a bar magnet are introduced into the same Erlenmeyer flask. Approximately 1 g cobaltocenium hexafluorophosphate (0.003 mol) is dissolved in 7.5 ml acetonitrile to prepare the oxidising solution. The oxidising solution was added dropwise using an additional ampoule. A total of 15 mL acetonitrile was used and the oxidising solution had a concentration of 0.5 mol/L. Vigorous mixing was maintained after the addition overnight for the reaction between the oxidant and the nitride.

The mixture was then decanted and transferred to a centrifuge tube. Centrifugation was carried out at a speed of 5000 rpm for 5 minutes using a centrifuge. After centrifugation, the powder and solution were separated.

Approximately 5 mL acetonitrile was introduced a second time to the centrifuge tube for rinsing, then a second centrifugation was carried out.

This rinsing-centrifugation step was repeated several times (3 times). At the end, the powder was placed in an oven (Buchi type) for drying at 90° C. under vacuum for one hour.

The delithiated material was obtained after drying.

A material is thus obtained at the end of the method according to the invention.

A diffractogram of the material obtained is then produced, as shown in FIG. 1 (curve B, material B).

A scanning electron microscope image of the material obtained by the method of the invention was also taken, as shown in FIG. 2B (material B).

It is clear that the material of formula Li₇MnN₄ has been modified.

More precisely, the material of formula Li_{5,3}MnN₄ was obtained. The presence of the material of formula Li_{5,3}MnN₄ was confirmed by the lattice parameter calculated from this diffractogram, which is 9.35 A.

A delithiation of the material of formula Li₇MnN₄ was thus achieved using the method according to the invention.

### Example 2: Use of the Material Obtained in Example 1 in a Half-Cell

The active material obtained in Example 1 was prepared in the form of a composite electrode and tested with a piece of lithium metal in a CR2032 button cell. The composite electrode was prepared by mixing 70% by weight of the active material obtained in example 1 with 22% by weight acetylene black and 8% by weight polytetrafluoroethylene (PTFE).

The separator used was a glass microfibre separator CAT No. 1823-070@marketed by Whatman.

The electrolyte used was 1 mol/L lithium hexafluorophosphate dissolved in a mixture of carbonate solvents with a 1:1:1 volume ratio of ethylene carbonate (EC), diethyl carbonate (DEC) and dimethyl carbonate (DMC).

Then a half-cell was assembled. The half-cell was assembled in a glove box.

### Electrochemical Test

Galvanostatic cycling was performed using a BioLogic VMP3 potentiostat with a cycling regime of C/20, as shown in FIG. 3. The potential window is between 1.6 V and 0.9 V.

In FIG. 3, the starting point x=0 corresponds to the active material obtained at the end of example 1. The potential at this point is E=1.7 V.

As x increases, the material reduces electrochemically and the potential of the material decreases. It is known that the initial form of Li₇MnN₄ is obtained when the potential has dropped to E=0.9 V. It can then be seen in FIG. 3 that x is approximately equal to 1.7 when E=0.9 V. In other words, when E=0.9 V, approximately 1.7 lithium cells have been electrochemically re-intercalated into the half cell. Thus, when x=0, the formula can be determined as being Li_{5,3}MNn₄.

Thus, the material obtained by way of the method according to the invention is the material of formula Li₇₋ₓMnN₄ (with x=1.7), a material which has therefore been delithiated.

This material can be used as an active material for the negative electrode of an Li-ion battery.

1. A method for delithiating a lithium and transition metal nitride, the method comprising:
a) mixing an oxidising agent with the lithium and transition metal nitride; and
b) recovering a material obtained at the end of a).

2. The method of claim 1, wherein the transition metal is at least one selected from the group consisting of Mn, Fe, Co, Ni, Cu, and mixtures thereof.

3. The method of claim 1, wherein the lithium and transition metal nitride is present as at least one material having a formula selected from the group consisting of Li₇MnN₄, Li₃FeN₂, Li_{2.6}Co_{0.4}N, Li_{2.0}Ni_{0.67}N, and Li_{2.57}Cu_{0.43}N.

4. The method of claim 1, wherein the lithium and transition metal nitride is of formula Li₇MnN₄ or of formula Li₃FeN₂.

5. The method of claim 1, wherein the oxidising agent comprises a cobaltocenium salt.

6. The method of claim 1, wherein the molar ratio between the oxidising agent and the lithium and transition metal nitride is 0.5 to 3.

7. The method of claim 1, wherein a) is carried out in the presence of a solvent.

8. The method of claim 7, wherein the solvent is an aprotic organic solvent.

9. The method of claim 7, wherein the solvent is at least one selected from the group consisting of ethylene carbonate, propylene carbonate, dimethyl carbonate, diethyl carbonate, ethyl and methyl carbonate, and mixtures thereof.

10. A negative electrode active material for a lithium-ion battery, comprising the material obtained by the method of claim 1.

11. The method of claim 5, wherein the oxidising agent comprises at least one selected from the group consisting of cobaltocenium hexafluorophosphate, cobaltocenium tetrafluoroborate, bis(pentamethylcyclopentadienyl)cobalt hexafluorophosphate, bis(pentamethylcyclopentadienyl)cobalt tetrafluoroborate hexafluorophosphate, and mixtures thereof.

12. The method of claim 8, wherein the solvent comprises at least one selected from the group consisting of acetonitrile, tetrahydrofuran, dimethylformamide, dichloromethane, ethyl acetate, and mixtures thereof.
